(19) United States
(12) Patent Application Publication
(10) Pub. No.: US 2001/0023180 A1
(43) Pub. Date: Sep. 20, 2001

(54) Wireless communication device with replenishable credit balance

(76) Inventor: Dietmar Sauer, Gutenbach (DE)

Correspondence Address: HENRY M FEIEREISEN, 350 FIFTH AVENUE, SUITE 3220, NEW YORK, NY, 10118

(21) Appl. No.: 09/809,116

(22) Filed: Mar. 15, 2001

(30) Foreign Application Priority Data
Mar. 17, 2000 (DE) 200 04 892.9
Dec. 1, 2000 (DE) 200 20 522.6

(51) Int. Cl. H04M 11/00

(52) U.S. Cl. 455/406; 455/405; 455/407; 455/408; 455/558

(57) ABSTRACT

A wireless communication device and system is described which can operate without requiring a subscription with the service provider. The communication device can be connected with a storage device, such as a chip card, which includes an identification number of the service provider and a replenishable credit balance that can be replenished offline or online using a banking affiliation of the user. The device can also include an electronic signature to facilitate secure transactions. The chip card may also be used as a conventional cash or credit card.

### CROSS-REFERENCES TO RELATED APPLICATIONS

This application claims the priority of German Patent Applications, Serial Nos. 200 04 892.9, filed Mar. 17, 2000, and 200 20 522.6, filed Dec. 1, 2000, the subject matter of which is incorporated herein by reference.

### BACKGROUND OF THE INVENTION

The invention relates to a wireless communication device intended for use without requiring a subscription with the service provider, and more particularly to a device having a replenishable credit balance that can be replenished offline or online using a banking affiliation of the user..

Wireless communication devices are typically set up to communicate with the ground stations operated by a service provider selected by the subscriber. The subscriber enters into a long-term contractual relationship with the service provider which may extend over a time period of a year or longer. Cancellation of the service agreement prior to the time period agreed to will result in substantial monetary penalties. Some subscribers may want to use their wireless communication device only occasionally or for emergencies. They may be inclined to purchase a wireless communication device at a reasonable cost and may subsequently want to purchase a certain amount of calling time, for example in the form of a certain number of time units, for just such occasional use.

Wireless communication devices are usually equipped with a so-called SIM card that can be programmed and provides non-volatile memory. The SIM card contains user identification information, such as the telephone number of the wireless communication device, the serial number of the device, optionally a user code (PIN code), and an identification of the service provider. It may also contain additional information such as a personal call number directory.

The service provider bills for the calls, with the user receiving periodically a statement. Because charges are billed afterwards, there is a considerable risk for the service provider that services rendered will not be paid for.

Wireless communication devices are known that can be operated with cards, such as prepaid calling cards having a stored monetary value equivalent to a fixed number of call charge units. This card carries a code which is communicated by telephone to the service provider in question, which then clears the card. The number of units can be decremented during or after the call. When the given number of call charge units has been used up, the card is no longer valid and can be disposed.

It would therefore be desirable to provide a device for storing information, for use in conjunction with a wireless communication device, which can be used for making calls immediately after it has been purchased but which still offers the network provider sufficient payment security.

### SUMMARY OF THE INVENTION

According to one aspect of the invention, the wireless communication device includes means for storing a telephone number, means for storing a serial number of the wireless communication device, means for storing a monetary value available for call charges and means for storing a banking affiliation of the user. The means for storing the monetary value and the banking affiliation can be in the form of a chip card that can be replenished. The chip card can also include means for storing the identification of a service provider so that the money available for call charges can be used—immediately after purchase of the device—in the network of the service provider for whom the device was sold. When all the available money has been used up, the card can be recharged again by storing a new monetary value.

The card can be recharged, for example, by communicating with banking affiliation of the user either online, i.e., using the wireless communication device, or offline, e.g., by connecting the wireless communication device or the card to another terminal that can communicate with banking affiliation of the user. In this way, the device or card can be recharged without the need for a cash transaction by simultaneously debiting the user's account with the sum of money desired for call charges. According to one embodiment, the wireless communication device may be used for online banking.

According to another feature of the present invention, the wireless communication device or card may include additional means for storing an electronic signature. In this way, the wireless communication device or card facilitates business transactions requiring a signature, insofar as electronic signatures are admissible. This embodiment provides additional security for the user identity which can then be verified by way of the user code (PIN-Code) and/or the electronic signature. The means for storing the bank affiliation of the user may be stored internally in the wireless communication device on a memory chip or on the separate card having a memory chip, such as a so-called chip card. Chip cards are known in the art.

An external read/write device may be provided to read the information stored on the memory chip or chip card and to store the balance after the call is completed and the charge for the call has been subtracted. The external read/write device may also be capable of reading the banking connection stored in the memory device and/or chip card of the wireless communication device. Furthermore, the external read/write device may be able to read the electronic signature. The read/write device can be part of or an accessory of a wireless communication device which may also be integrated in another piece of equipment, for example a portable computer.

According to another aspect of the invention, the wireless communication device may be connectable with a remote device for storing information, wherein this remote device has means for storing a cash balance available for call charges as well as means for storing a banking affiliation of a user and means for decrementing the cash balance to reflect the calling charges. The remote device may also include means for storing an electronic signature and a reading device for reading the stored electronic signature.

The wireless communication device of the invention allow the user to make or receive a call immediately after purchasing the communication device and have the banking affiliation stored in memory in the communication device or in a remote device, such as a chip card. Because the service provider's code and the billing information are stored on the device and/or card, the call is directed automatically through its network without the need to enter of billing information. The memory of the wireless card communication device or the chip card can be replenished—assuming a banking connection can be established—either directly or at a suitably equipped terminal. The chip card according to the invention thus extends the advantages of the familiar telephone cards for use with land lines and a single provider to wireless communication devices, which can operate with different network providers. The respective service provider enjoys high payment security because payment is linked to the banking affiliation of the user, with the network provider's identification code ensuring payment.

The chip card may operate not only as a customary telephone card, but also as a cash card, bank card or credit card. The card may be used inside a wireless communication device or in appropriate accessory equipment which is connected with the wireless communication device via a wired or wireless link. The wireless communication device may also be integrated in another piece of equipment, for example a computer. A wireless communication device of this type may be useful for users who want to use their wireless communication device only occasionally or for emergencies and do not intend to receive incoming calls.

### BRIEF DESCRIPTION OF THE DRAWING

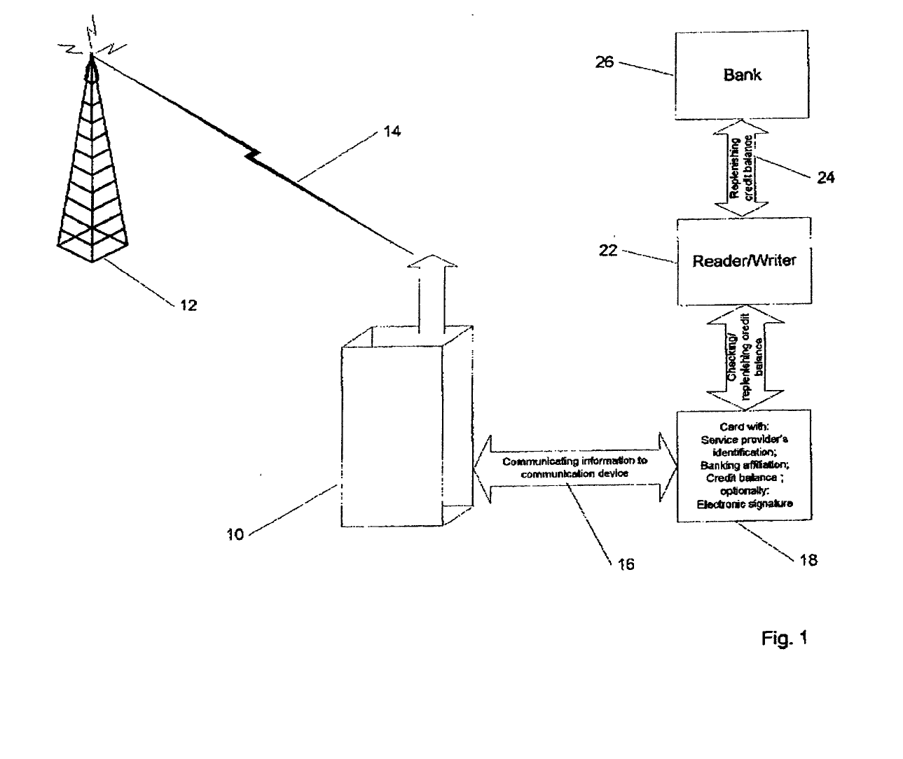

Other features and advantages of the present invention will be more readily apparent upon reading the following description of a preferred exemplified embodiment of the invention with reference to the accompanying drawing, in which FIG. 1 is a schematic block diagram of a wireless communication system with a storage device according to the invention.

### DETAILED DESCRIPTION OF PREFERRED EMBODIMENTS

Turning now to FIG. 1, there is shown a schematic block diagram of a wireless communication system 10, such as a mobile phone or Internet appliance, for communication via a wireless link 14 with a radio tower 12 operated by a service provider. Before the communication device 10 can operate within the communication network of the service provider, a card 18 with stored information related to the service provider's identification, such as a PIN code for a service provider, a dial-in number, a code for dialing into the telephone network, free hotline numbers, GSM compatibility, a serial number and card type, as well as an available call-charge or credit balance is placed in communication with the communication device 10 via a communication link 16, such as a cradle. The different identification numbers may be stored in the same or in an additional memory chip (not shown) disposed on the card. A banking affiliation may also be stored on the card, either on the same memory chip(s) or on an additional memory chip. A card 18 of this type can, for example, be distributed by businesses which are independent of the service provider, for example at kiosks. The user inserts the card 18 in or connects the card 18 to his/her wireless communication device 10, and by virtue of the service provider identification stored on the card 18, every call will be directed through the network of this particular provider. After a call is ended, the balance remaining after subtraction of the call charge is stored. The service provider may allow calls to proceed only if the credit balance stored on the card exceeds a predetermined value. Since the user's banking connection is also stored on the card, the card can be replenished at suitable read/write terminals 22 which are connectable to a banking affiliation 26 via a communication link 24, for example, a dial-up phone line, or by other means, such as online banking. If desired, identification for a different service provider can be stored at the same time.

The card user's electronic signature, for example in form of a PIN number, can be stored additionally on one of the memory chips or on an additional memory chip, and can be read and transmitted for business transactions conducted via the wireless communication device 10, with the electronic signature providing additional security for the transaction.

While the invention has been disclosed in connection with the preferred embodiments shown and described in detail, various modifications and improvements thereon will become readily apparent to those skilled in the art. For example, the card can be incorporated in the wireless device itself, with the wireless device placed in a cradle for replenishing the stored credit amount. Accordingly, the spirit and scope of the present invention is to be limited only by the following claims.

What is claimed as new and desired to be protected by Letters Patent is set forth in the appended claims:

What is claimed is:

1. A device for storing information, for use in conjunction with a mobile telephone, wherein a first means is provided for storing a sum of money available for call charges and a second means is provided for storing the identification of a telephone network provider.

2. The device of claim 1, and further comprising a third means for storing a banking connection.

3. The device of claim 1, and further comprising a fourth means for storing an electronic signature.

4. The device of claim 1, wherein the device is designed as a card having at least one memory chip thereon.

5. The device of claim 1, wherein the first and the second means are each configured as a memory chip on a card.

6. A read/write device for reading the sum of call-charge money stored in a first storing means provided for storing a sum of money available for call charges, and for storing a new sum of call-charge money in the storing means, and for reading the telephone-network-provider identification stored in a second storing means for storing an identification of a telephone network provider.

7. The read/write device of claim 6, and further comprising a third storing means for storing a banking connection, and reading means for reading the banking connection stored in the third storing means.

8. The read/write device of claim 6, and further comprising fourth storing means for storing an electronic signature, and reading means for reading the electronic signature stored in the fourth storing means.

9. The read/write device of claim 6, wherein the read/write device is part of or an accessory of one of a mobile telephone, a mobile telephone which is integrated in another piece of equipment.

10. A mobile telephone, comprising a device having a first means for storing a sum of money available for call charges, a second means for storing the identification of a telephone network provider, and a read/write device for reading the sum of call-charge money stored in the first means and for storing a new sum of call-charge money therein, and for reading the telephone-network-provider identification stored in the second means.

11. The mobile telephone of claim 10, wherein the device includes a third means for storing a banking connection, and further comprising a reading device for reading the stored banking connection.

12. The mobile telephone of claim 10, wherein the device has a fourth means for storing an electronic signature, and further comprising a reading device for reading the stored electronic signature.

13. A wireless communication device capable of interfacing with a wireless communication network of a service provider without requiring a subscription with the service provider, the wireless communication device comprising:
communication means for transmitting information of intelligence to and receiving such information from the wireless communication network,
means connected to the wireless communication device for storing a credit balance available for call charges, and
means for storing a banking affiliation, wherein the credit balance can be replenished via the banking affiliation.

14. The device of claim 13, and further comprising means for storing an electronic signature.

15. The device of claim 13, and further comprising means for storing a service provider identification.

16. The device of claim 15, wherein the means for storing the credit balance, the banking affiliation and the telephone-network-provider identification are remote from the wireless communication device and implemented as a card having at least one memory chip thereon.

17. A read/write device connectable to a wireless communication device capable of interfacing with a wireless communication network of a service provider, the read/write device capable of reading from a storage means connected thereto a credit balance and an identification of the service provider, and storing a new credit balance in the storage means, and allowing the wireless communication device to transmit information of intelligence to and receive such information from the wireless communication network if the credit balance exceeds a predetermined amount determined by the service provider.

18. The read/write device of claim 17, and further comprising means for reading a banking affiliation stored in the storage means.

19. The read/write device of claim 17, and further comprising means for reading an electronic signature stored in the storage means.

20. The read/write device of claim 17, wherein the read/write device is part of a wireless communication device which is integrated in another piece of equipment.

21. A wireless communication system capable of interfacing with a wireless communication network of a service provider, comprising:
a wireless communication device for transmitting information of intelligence to and receiving such information from the wireless communication network;
a read/write device connectable to the wireless communication device and capable of reading from a storage means connected thereto a credit balance and an identification of the service provider, and storing a new credit balance in the storage means, and allowing the wireless communication device to transmit information of intelligence to and receive such information from the wireless communication network if the credit balance exceeds a predetermined amount determined by the service provider.

22. The wireless communication system of claim 21 configured for storing in and reading from the storage means a banking affiliation.

23. The wireless communication system of claim 21, configured for storing in and reading from the storage means an electronic signature.

24. A method of allowing a user to transmit to or receive from a wireless communication network operated by a service provider information of intelligence using a wireless communication device without requiring a subscription with the service provider, comprising:
providing a remote memory device having a stored credit balance that can be remotely replenished, a service provider identification and a banking affiliation;
reading information which includes the stored credit balance, the service provider identification and the banking affiliation and communicating the information to the wireless communication device;
the service provider allowing transmission and reception of the information of intelligence between the wireless communication device and the network depending on the stored credit balance and decrementing the stored credit balance; and
the user remotely reading and replenishing the decremented stored credit balance using the stored banking affiliation.
